(19) United States
(12) Patent Application Publication
(10) Pub. No.: US 2016/0127319 A1
(43) Pub. Date: May 5, 2016

(54) METHOD AND SYSTEM FOR AUTONOMOUS RULE GENERATION FOR SCREENING INTERNET TRANSACTIONS

(71) Applicant: ThreatMetrix, Inc., San Jose, CA (US)

(72) Inventors: Tao Xiong, Cupertino, CA (US); Andreas Baumhof, Mountain View, CA (US); Haunjiin Chen, Cupertino, CA (US); Song Cui, Sunnyvale, CA (US); Matthias Michael Baumhof, Mountain View, CA (US)

(21) Appl. No.: 14/933,942

(22) Filed: Nov. 5, 2015

Related U.S. Application Data
(60) Provisional application No. 62/075,797, filed on Nov. 5, 2014.

(51) Int. Cl. H04L 29/06; G06N 5/04; G06N 99/00

(52) U.S. Cl. CPC H04L 63/0263; G06N 99/005; G06N 5/046

(57) ABSTRACT

A computer system for evaluating transactions in a network includes a storage medium, one or more processors coupled to said storage medium, and computer code stored in said storage medium. Computer code, when retrieved from said storage medium and executed by said one or more processor, causes the system to receive a plurality of transactions over the network, and automatically generating rules for evaluating the transactions, using the computer system. Each of the rules includes variables and partition of values of the variables, each partition having an assigned score. The computer system also automatically combining the rule scores to form a final score.

### CROSS-REFERENCES TO RELATED APPLICATIONS

This application claims the benefit of U.S. Provisional Application No. 62/075,797, titled “Method and System for Autonomous Rule Generation for Screening Internet Transactions,” filed Nov. 5, 2014, which is incorporated by reference in its entirety.

### COPYRIGHT NOTICE

All content included such as text, graphics, logos, button icons, images, audio clips, digital downloads, data compilations, and software, is the property of its supplier and protected by United States and international copyright laws. The compilation of all content is protected by U.S. and international copyright laws. Copyright © 2014 ThreatMetrix, Inc. All rights reserved.

### BRIEF DESCRIPTION OF THE INVENTION

Embodiments of the invention can provide both best performing black-box supervised predictive models as well as highly interpretable and accurate rules all at once. To the best knowledge of the inventors, this is the first industrial application of advanced autonomous rule generation technology. The inventors believe the methods and systems provided in embodiments of this invention could significantly improve the productivities and ROI of the users in their business enablement and fraud detection efforts, among other things.

Some embodiments may provide for computer system for evaluating transactions in a network, the system comprising: a storage medium; one or more processors coupled to said storage medium; and computer code stored in said storage medium wherein said computer code, when retrieved from said storage medium and executed by said one or more processor, results in: retrieving from the computer-readable storage medium information about network transactions; generating, with one or more of the computer processors, a machine learning model for evaluating the network transactions; generating, with one or more of the computer processors, a plurality of rule candidates from the machine learning model; reducing with one or more of the computer processors, the number of rules in the plurality of rule candidates; forming an optimized set of rules for evaluating the network transactions; and outputting the optimized set of rules in a human readable form.

Some embodiments may provide for, in a network monitoring tool implemented in a computer system having one or more computer processors and a computer-readable storage medium, a method for evaluating transactions on a network including: retrieving from the computer-readable storage medium information about network transactions; generating, with one or more of the computer processors, a machine learning model for evaluating the network transactions; generating, with one or more of the computer processors, a plurality of rule candidates from the machine learning model; reducing with one or more of the computer processors, the number of rules in the plurality of rule candidates; forming an optimized set of rules for evaluating the network transactions; and outputting the optimized set of rules in a human readable form.

Some embodiments may provide for, in a computer system, a method for evaluating transactions in a network, the method comprising: receiving a plurality of transactions over the network; automatically generating rules for evaluating the transactions, using the computer system, each of the rules includes variables and partition of values of the variables, each partition having an assigned score; and using the computer system, automatically combining the rule scores to form a final score.

Some embodiments may include circuitry and/or media configured to implement the methods and/or other functionality discussed herein. For example, one or more processors, and/or other machine components may be configured to implement the functionality discussed herein based on instructions and/or other data stored in memory and/or other non-transitory computer readable media.

These characteristics as well as additional features, functions, and details of various embodiments are described below. Similarly, corresponding and additional embodiments are also described below.

### BRIEF DESCRIPTION OF THE DRAWINGS

FIG. 1 is a simplified block diagram illustrating an on-line transaction protection system according to an embodiment of the present invention;

FIG. 2 is a simplified flow diagram for a method 200 for evaluating transactions in a network according to an embodiment of the present invention;

FIG. 3 is a simplified block diagram of a computer system 300 according to an embodiment of the present invention; and

FIG. 4 shows an example of a gradient boosting regression tree (GBRT) according to an embodiment of the present invention.

### DETAILED DESCRIPTION OF THE INVENTION

The inventors of this invention have identified many limitations of conventional systems for evaluating network transactions. Translating a few fraudulent and legitimate data instances into a set of interpretable rules could be a human intensive effort. Most good performing machine-learning algorithms are black-box magic. They produce highly accurate predictions, while in the meanwhile models themselves are highly nonlinear and hard to decipher. Still, customers have to spend tremendous time analyzing data to generate intelligent rules and their optimal combinations to fulfill their business needs. Moreover, usually each individual rule is built independently without modeling interactions among the rules which in most many cases can results in a suboptimal rule set. Therefore there is a need for improved methods and systems for evaluating network transactions.

Conventional autonomous rule creation is a daunting task for reasons not limited to: there is exponential number of candidates for rule cutoffs and weights combinations. So the search for the optimal parameters is almost impossible. Moreover, using a “linear” model to approximate highly nonlinear models usually lead to inferior model performance.

Embodiments of the present invention provide methods and systems for generating decision rules automatically. Such methods and systems are provided to allow users to configure real time rules to enable more transactions/revenues and/or to detect fraudulent/anomalous transactions. In some embodiments of the present invention, a rule can be an “if . . . then . . . ” statement, where the if statement defines a partition of a set of variables, and the then statement corresponds to the predicted trustworthiness or riskiness. In some embodiments, variables in this context relate to entities or attributes in the ThreatMetrix language, and a rule in the ThreatMetrix system is one of many types. Types can include Velocity rules, anomaly rules, Persona ID rules, etc. The rule scores can be combined together to provide a final score for decision making.

Embodiments of the present invention provide an intelligent system where highly predictive and interpretable rules and their optimal combinations are generated in an autonomous manner. Each rule is configured to model data patterns in different parts of the input space and their judicious combination provides a powerful and interpretable final model that could be used to meet various predictive modeling needs. The system automatically determines the number of the rules that is optimal to solve the problem that is presented. In some embodiments, users have options to set the maximum number of rules generated. Moreover, in addition to the accurate rule set, the system also outputs a best performing black-box supervised predictive model, which could be leveraged by the modeler and analyst as well. Users have many options on how the batch model and rule set are built.

In summary, embodiments of the invention generate both best performing black-box supervised predictive models as well as highly interpretable and accurate rules all at once. To the best knowledge of the inventors, this is the first industrial application of advanced autonomous rule generation technology. The inventors believe the methods and systems provided in embodiments of this invention could significantly improve the productivities and ROI of the users in their business enablement and fraud detection efforts.

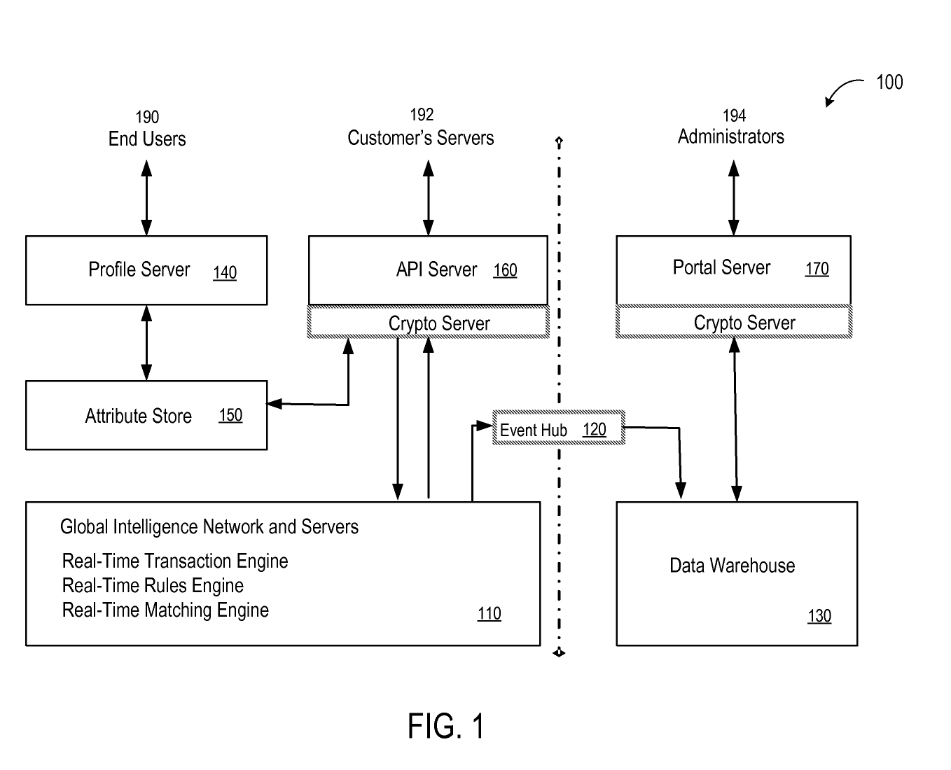

FIG. 1 is a simplified block diagram illustrating an on-line transaction protection system according to an embodiment of the present invention. As shown in FIG. 1, system 100 leverages the collective power of the global intelligence network and servers 110 to detect and eliminate fraud and other cybercrimes. The system provides comprehensive, context-based authentication, protecting mission-critical enterprise applications from hackers and fraudsters, providing protection for all types of online transactions, including, but not limited to, guarding against account takeover, card-not-present, and fictitious account registration frauds. In some embodiments, the system detects web fraud by analyzing online identities and their associated devices, using anomaly and velocity rules to make real-time decisions. It builds a comprehensive online persona of each user attempting an online transaction, by combining online identities and device fingerprints while also detecting anomalies and malware-based compromises. Business policies options allow configuration of user trust levels to fit each organization's business model. Shared intelligence across millions of daily transactions processed by the global intelligence network provides predictive analytics, to protect online businesses and reduce customer friction. The system can provide the benefits of unified intelligence, simplified implementation and management, and better overall coverage. Enterprises can experience an increase in productivity by confidently allowing employees to work remotely using their own devices. Online merchants, financial institutions, and other businesses can increase business by authorizing more good customers, while screening out fraudsters and criminal activity.

As shown in FIG. 1, system 100 includes an event hub 120 coupling the global intelligent network and servers 110 with a data warehouse 130, which includes various databases. The global intelligent network and servers 110 can include real-time transaction engines, real-time rules engines, and real-time matching engines, etc. End users 190 can access the system through a profile server 140, which is coupled to an attribute store 150. Customer's servers 192 can access the system through an API server 160, which can include an encryption server. Administrators 194 can access the system through a portal server 170, which can also include an encryption server.

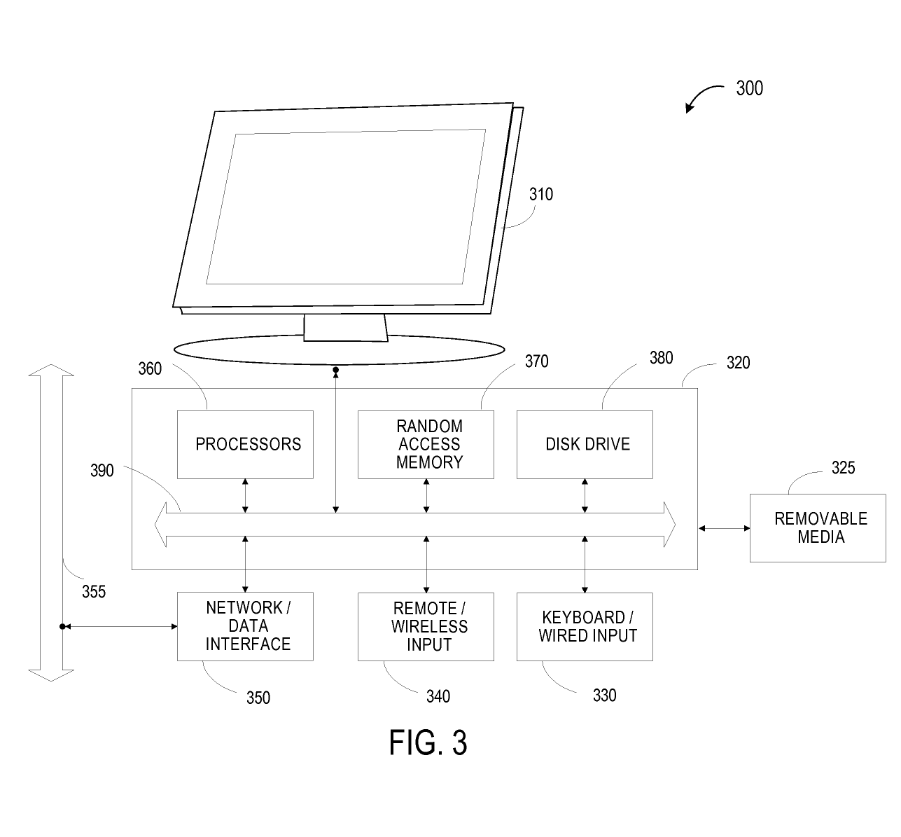

In embodiments of the present invention, the various servers mentioned above can be implemented in a computer system. An example of such a computer system is described in more detail below with reference to FIG. 3. In particular, the real-time rules engine in the global intelligence network and servers mentioned above can include computer systems for evaluating transactions in a network. Examples of such computer systems and related methods are described below.

According to an embodiment of the present invention, a computer system for evaluating transactions in a network, the system includes a storage medium, one or more processors coupled to said storage medium, and computer code stored in said storage medium wherein said computer code, when retrieved from said storage medium and executed by said one or more processor, results in:

receiving a plurality of transactions over the network;

automatically generating rules for evaluating the transactions, using the computer system, each of the rules includes variables and partition of values of the variables, each partition having an assigned score; and

using the computer system, automatically combining the rule scores to form a final score.

According to another embodiment of the present invention, a computer system for evaluating transactions in a network, the system includes a storage medium, one or more processors coupled to said storage medium, and computer code stored in said storage medium wherein said computer code, when retrieved from said storage medium and executed by said one or more processor, results in:

retrieving from the computer-readable storage medium information about network transactions;

generating, with one or more of the computer processors, a machine learning model for evaluating the network transactions;

generating, with one or more of the computer processors, a plurality of rule candidates from the machine learning model;

reducing with one or more of the computer processors, the number of rules in the plurality of rule candidates;

forming an optimized set of rules for evaluating the network transactions; and

outputting the optimized set of rules in a human readable form.

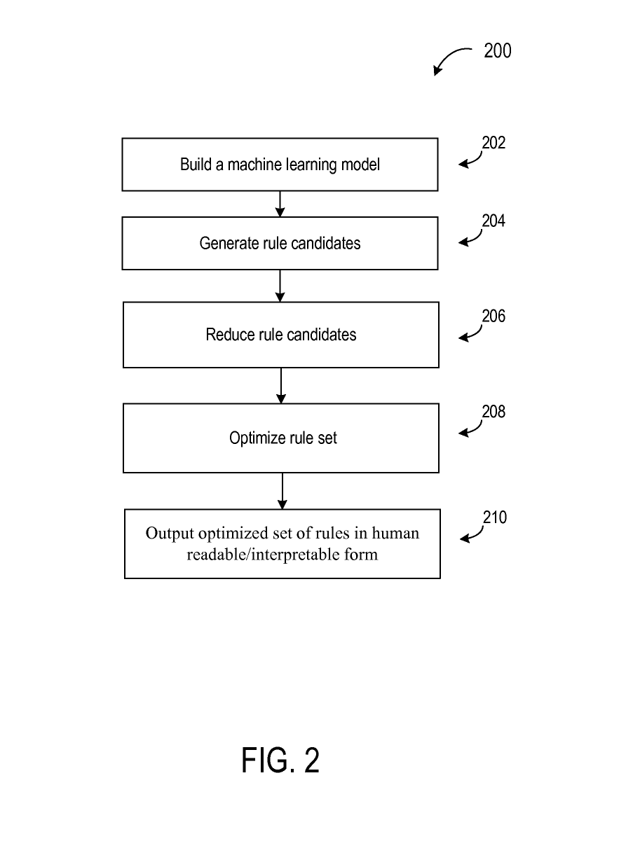

FIG. 2 is a simplified flow diagram for a method 200 for evaluating transactions in a network according to an embodiment of the present invention. This diagram is merely an example, which should not unduly limit the scope of the claims herein. One of ordinary skill in the art would recognize other variations, modifications, and alternatives. As shown, the method includes building a machine learning model, step 202. This step can involve retrieving from the computer-readable storage medium information about network transactions, and generating, with one or more of the computer processors, a machine learning model for evaluating the network transactions. Here, retrieving information about network transactions can involve receiving historical information about network transaction. In some embodiments, retrieving information about network transactions can involve receiving real-time on-line information about network transactions.

Depending on the embodiments, information about network transactions can include information about online identities and their associated devices, and can take various forms. For example, an internet transaction can be categorized into layers such as USER, APPLICATION, PROTOCOL, CONNECTION, and HARDWARE according to an embodiment of the invention. Each layer has characteristics of interest or identification attributes. According to an embodiment of the invention, some examples of the attributes at each level are listed below:
USER: Skype id, from address, digital certificates, Biometric, Credit Card transactions
APPLICATION: IRC/CHAT, DKIM, VOIP,
PROTOCOL: port, IPv6
CONNECTION: IP address, URL, URN
HARDWARE: hardware profile, clock skew, Pc Serial Number (IPv6), nic.

In some embodiments, generating the machine learning model can include using one or more of neural networks methods, support vector machine (SVM) methods, or ensemble methods. In some embodiments, generating the machine learning model may include selecting a machine learning algorithm, determining a machine learning outcome (e.g., probability of fraud), and determining variables that impact the outcome (e.g., attributes of the transaction).

The method also includes generating rule candidates, step 204. Here, the method includes generating, with one or more of the computer processors, a plurality of rule candidates from the machine learning model. For example, the rule candidates may be generated based on applying the machine learning model to training data. The training data may include variable values and associated outcomes (e.g., whether the collection of variable values indicates a fraudulent transaction or not). Using the training data and the machine learning model, the candidate rules may be programmatically generated as best fit functions for relating the variables to an output indicating existence or probability of fraud.

At step 204, a large number of rule candidates are generated. Here, a rule can involve a plurality of variables and partitions of the values of variables. Depending on the embodiments, generating the plurality of rule candidates from the machine learning model can include using one or more of a discretised interpretable multilayer perceptron (DIMLP) method or a C4.5rules method.

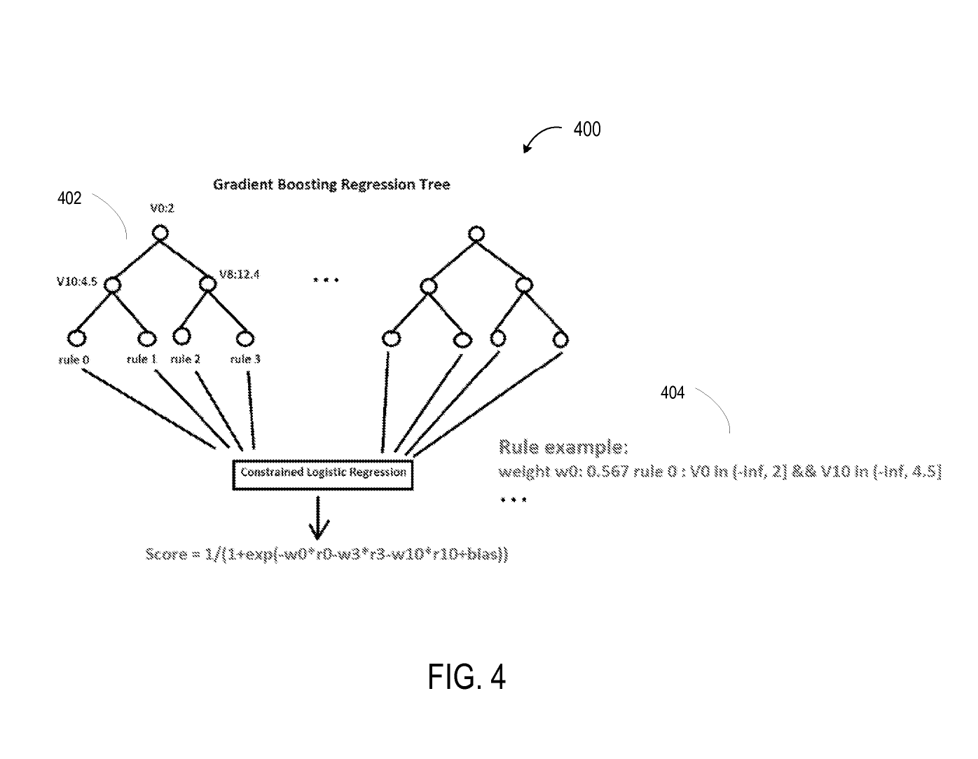

In some embodiments, generating the candidate rules may include using gradient boosting regression trees (GBRT). FIG. 4 shows an example of a GBRT 400 in accordance with some embodiments. The GRBT 400 may include a series of regression trees, such as regression tree 402, defining relationships between rules and variable values. For example, the regression tree 402 includes a variable V0 node defining a test for the V0 variable (e.g., whether the value is greater than or less than 2). The leaf nodes of the root V0 node represents a decision path taken based on the V0 variable value. Here, the V0 node is selected when V0 is less than 2, and the V8 node is selected when the V0 node is greater than 2. The value 2 for the V0 node, and the value 4.5 for the V10 node, represents a classification rule. Similar classification rules may be defined for other nodes to complete the regression tree.

The lower level nodes of the regression tree 402 may include rules, such as the rules 0, 1, 2, and 3 nodes). For example, the rule 0 node can be reached based on the starting with the regression tree 402, traversing from the V0 node to the V10 node (e.g., when V0 is between [−inf, 2]), then traversing from the V10 node to the rule 0 node (e.g., when V10 is between [−inf, 4.5]). As such, the rule 0 node may be defined as shown at 404 including the variables V0 and V10 with their respective partitions (e.g., between [−inf, 2] for the V0 variable and [−inf, 4.5] for the V10 variable). Each rule or rule node may be further associated with a weighting factor (e.g., 0.567 for the rule 0 node).

Generating regression trees and associated rules may also include determining the tree level of the regression trees. The tree level may be define the number of variables used in each regression tree, and thus the number of levels of the tree. Higher tree levels may result in greater accuracy or precision, but may also require longer and intensive data processing. Furthermore, higher tree levels may result in overfitting. As such, an optimal number of tree levels should be selected depending various requirements. In one embodiments, the tree level may be set to 2, meaning that each regression tree includes two levels and at most three variables (e.g., as shown by the regression tree 402 including 2 variable levels, and three variables V0, V8, and V10).

Use of the GBRT allows for more stable threes that have better performance than conventionally used random forest (RF) techniques. Regression trees may be used instead of decision trees. The regression trees may output different probabilities for fraud for different rules (e.g., instead of binary “yes” or “no” decisions), as represented by the weighting factor associated with each rule. In some embodiments, the probability of fraud from applying one or more applicable rules may be defined with respect to a “fraud score” that is determined as a function of the weighting factors associated with each applicable rule.

For example, in some embodiments, the fraud score for a set of variable values of a transaction when applying rule 0, rule 3 and rule 10 (e.g., as determined by the variable values applied to a regression tree) may be given by:

Fraud Score=1/1+e^{(-(w0*r0)-(w3*r3)-(w10*r10)+bias)}

Here, (w0*r0) is the weight of the rule 0, (w3*r3) is the weight of the rule 3, (w10*r10) is the weight of a rule 10, and bias is a (e.g., optional) constant value output from the machine learning algorithm. Similarly, the fraud score equation may be applied to different sets of rules and their associated values, and may be defined by the equation:

Fraud Score=1/1+e^{(-(Σwi)+bias)}

Here, i represents an index number that takes on a value associated with each selected rule used to compute the fraud score, and Wi represents the associated weight for each rule i.

Gradient boosting may be applied to generate multiple regression trees, such as in a sequential manner to maximize accuracy. For example, the first regression tree may be used to compare with test or training data to evaluate the accuracy of the first regression tree. Next a second regression tree may be generated to minimize differences between the output data (e.g., fraud scores) of the first regression tree and the outcomes of the test or training data, and so forth until multiple regression trees and associated rules are generated.

The method in FIG. 2 also includes reducing rule candidates, at step 206. Depending on the embodiment, reducing the number of rules in the plurality of rule candidates can include using one or more of methods based on business needs or heuristic methods. As described above, machine learning models do not necessarily provide explicit rules in any human interpretable form. In some embodiments, the method may include generating a manageable number of rules that are human readable or interpretable. In some embodiments, a rule can be in a form of “if . . . then . . . ” statement.

The method also includes optimizing the rule set, at step 208. In some embodiments, forming an optimized set of rules can include selecting variables and selecting partitions of values of the variables (e.g., generating the regression trees). In some embodiments, the method can also include selecting the top performing rules and determining the optimal weight combination for the rules. In some embodiments, the method can include receiving, from a user, the number of rules and the number of variables for each rules. For example, the user may specify that at most 3 variables can appear in a rule, resulting in the limiting of regression tree depth. The method may further include recalculating the regression trees, rules, and performing optimizations based on the input variable count or tree depth. Advantageously, the rules may be more readable and customers may more easily detect fraud patterns without comprising accuracy. In some embodiments, forming an optimized set of rules can include using one or more of filter methods or embedded methods. Examples of filter and embedded methods, applicable in some embodiments, are discussed in Isabelle Guyon and Andre Elisseeff, “An Introduction to Variable and Feature Selection,” 3 Journal of Machine Learning Research, 1157-1192 (2003).

In some embodiments, optimizing and/or reducing the rule candidates may include integrating the gradient boosting regression trees (GBRT) with constrained logic regression (LR) as a hybrid model. For example, a large data set of regression trees and rules may be generated to capture (e.g., all possible) fraud patterns in the rulesets as discussed above. However, the large number of regression trees may result in overfitting (e.g., model describes random error or noise) or difficulty for manual administration of the rules, and thus rules may be optimized or reduced based on selecting the most relevant rules.

Reducing/optimizing the rule candidates may include the use of constrained logic regression, such as L1 regularization. For example, L1 regularized logistic regression may be applied to the generated rules at 204 to programmatically select the most relevant rules with minimum sacrifice in accuracy. In some embodiments, the L1 regularized logistic regression may be applied to the generated rules to change weighting factors of rules in addition to the selection of rules from the larger generated set. The change of weighting factors may be performed to optimize the outcomes (e.g., fraud scores) for the reduced rule set such that the reduced rule set performs similarly to the entire rule set in terms of transaction fraud detection.

The method also includes outputting the optimized set of rules in a human readable/interpretable form, at step 210. Advantageously, the reduction to the number of rules may help human operators perform manual fraud identification based on manual inspection. This is because applying the full set of generated rules would be too information intensive for a human operator. Thus the optimized rule set provides for a technique wherein machine learning is used to provide a small number of optimized rules that remain highly effective for or relevant to fraud detection. However, fraud detection is not limited to human tracking, and may use programmatic tracking such as by comparing fraud scores to a predetermined threshold score to determine whether a transaction may be fraudulent or not. It is appreciated that in various embodiments, other times of machine learning and/or regression algorithms may be used in alternative or addition to the GBRTs with constrained LR as a hybrid model.

The above sequence of steps provides a method for tracking machines on a network of computers according to an embodiment of the present invention. As shown, the method uses a combination of steps including a way of using an IP address along with other attributes to determine whether an unknown host is a malicious host. Other alternatives can also be provided where steps are added, one or more steps are removed, or one or more steps are provided in a different sequence without departing from the scope of the claims herein.

The following is an example illustrating the methods described above for extracting information from transaction database, and deriving a set of rules. First, listed below are 20 samples of simulated network transaction attributes and their values extracted from the database. As can be seen, each sample transaction is represented by 10 variables, each with a simulated value. For example, a variable could represent an IP address, a city of origination, etc.

| | [,1] | [,2] | [,3] | [,4] | [,5] | [,6] |
|---|---|---|---|---|---|---|
| [1,] | 0.47420667 | −1.5651690 | 0.62336229 | −0.1046376 | 1.6673772 | −1.94956265 |
| [2,] | 0.87670850 | 0.9320731 | 0.88560311 | −0.2505151 | −1.5455382 | 0.31354884 |
| [3,] | 0.27816957 | −0.1021313 | 0.88148858 | −1.2800450 | −0.6539955 | −0.30196656 |
| [4,] | 1.31667632 | −1.1458002 | 0.62189523 | 1.8049990 | −1.6412521 | −1.16246406 |
| [5,] | 0.33620254 | 0.1755403 | −0.69439653 | −0.2890379 | 0.3449416 | 0.72712512 |
| [6,] | −0.23420624 | −0.8501591 | 1.23353480 | 0.9714619 | 1.6116170 | −0.87474466 |
| [7,] | −0.82657715 | 0.5837219 | 1.79243446 | −0.5016046 | 2.2991846 | 1.38896905 |
| [8,] | 0.63075617 | 0.3896350 | 0.72797860 | −0.8369686 | 1.1869957 | 0.82132505 |
| [9,] | 0.15232658 | 1.8230923 | −0.41185478 | 0.8809986 | −0.6077088 | 0.34100253 |
| [10,] | −1.52664572 | 0.1539828 | −0.93181307 | −0.9899146 | 1.0208809 | −0.37930510 |
| [11,] | 1.21488127 | −0.1915228 | −0.13234357 | 0.1083634 | −0.2377238 | 0.98511016 |
| [12,] | 1.20478366 | −1.8770801 | −0.90500995 | −0.7363432 | −0.3365534 | 0.88520668 |
| [13,] | 1.71744007 | 0.7024201 | −0.97066594 | −0.3570893 | 0.9656599 | 0.96796226 |
| [14,] | 0.05659319 | 0.8932954 | 1.10811443 | 3.3442477 | −0.8877817 | 0.06558694 |
| [15,] | −1.72257802 | 0.7291162 | −2.30274018 | 0.6608113 | −0.2775764 | −0.31514970 |
| [16,] | −0.10562723 | −0.6235125 | 0.46467271 | −0.6337743 | −0.2641909 | 1.05097218 |
| [17,] | 0.96033217 | 1.1212614 | −0.34122547 | −1.3035934 | 1.8916425 | −0.23562268 |
| [18,] | −2.34740004 | −0.6943281 | 0.20149435 | 1.4314172 | −0.3834815 | −1.54560317 |
| [19,] | 1.41321386 | −0.2617908 | −0.68585643 | 0.0895387 | 1.0426490 | −0.56079272 |
| [20,] | 0.09054383 | 0.6447029 | 0.08476866 | −1.2145872 | −0.1039609 | −0.92557049 |

| | [,7] | [,8] | [,9] | [,10] |
|---|---|---|---|---|
| [1,] | −1.2541609 | 0.29772640 | 0.83309138 | 0.3945625241 |
| [2,] | −0.3393755 | 0.63563170 | −0.57447626 | −0.0119738252 |
| [3,] | 0.8816911 | 1.23256257 | 0.03376701 | −1.2805419510 |
| [4,] | 0.4420086 | 0.99530080 | 0.49241820 | −1.1239512615 |
| [5,] | −0.1726996 | −0.95070662 | −0.57066991 | −0.5952470989 |
| [6,] | 0.1181694 | 1.87544298 | 0.37835318 | 1.2660072847 |
| [7,] | −0.2355918 | 0.47520833 | 0.36889188 | 0.1072713614 |
| [8,] | 0.5691721 | −0.01569326 | 0.34652663 | 1.1448539029 |
| [9,] | −0.4588475 | −0.62552254 | 0.01412860 | −0.7269363311 |
| [10,] | −0.2640020 | 1.19774185 | 0.02312771 | 2.6610588053 |
| [11,] | 2.3898850 | −0.70738128 | 1.62046869 | −0.1374333033 |
| [12,] | −1.4899394 | −0.36337196 | −0.51392086 | −1.0479879285 |
| [13,] | −0.4350589 | −0.54102570 | −0.27676530 | 0.5178952752 |
| [14,] | −0.1217844 | 0.97196765 | 0.06943565 | 0.8553525300 |
| [15,] | 0.6286805 | 1.11358136 | −0.25472667 | −0.5044220621 |
| [16,] | −1.1615145 | 0.33096587 | −0.45361313 | −1.6033627072 |
| [17,] | 0.6335889 | 0.53362310 | −0.67512047 | −0.6581566850 |
| [18,] | −0.9640225 | 0.35205197 | 0.49398342 | 0.6020377621 |
| [19,] | 0.3670221 | −0.78262656 | −1.84572717 | −0.0005931704 |
| [20,] | 0.4024705 | −0.47638917 | −0.62729359 | 0.1690218790 |

y
[1] 1 0 0 1 0 1 1 0 0 1 1 1 0 1 1 0 0 1 0 0

Listed below are an example of simulated optimized set of rules provided by the system. As can be seen, 18 rules are provided. Each rule has three variables with their respective partitions. Each rule also has a weighting factor associated with it. For example, rule #0 specifies value ranges for three variables V4, V9, and V1, with a weighting factor of 112.2477549398298. The rule would be a “if . . . then . . . ” statement that would be true if variables V4, V9, and V1 have values that are in their respective ranges. The rules can be combined using their weighting factor to form a policy decision. In some embodiments, each rule can correspond to an attribute of a transaction, and its partition would represent a range of attribute values. In an embodiment, an optimal set of rules can include a manageable number of rules, for example, 20 to 50 rules. The rules can be arranged in a human interpretable form, for example, with the attributed name for the variable symbols, and the meaning of the value partitions.

| | | |
|---|---|---|
| 0 | weight: 112.2477549398298 | rule: V4 in (−0.5737344324588776, 1.1152753233909607] |
| | | && V9 in (−Infinity, 1.3388907313346863] && V1 in (−Infinity, 1.0442261099815369] |
| 1 | weight: 537.3093235051548 | rule: V8 in (−0.524017870426178, 1.284083902835846] && |
| | | V0 in (−Infinity, 1.3535232543945312] && V6 in (−Infinity, 0.9653857052326202] |
| 2 | weight: 796.8227756128177 | rule: V0 in (−0.5260847508907318, 0.8676625788211823] |
| | | && V1 in (−Infinity, 1.1384828686714172] && V3 in (−Infinity, 0.9167297780513763] |
| 3 | weight: 285.9103707789464 | rule: V4 in (−0.5622737407684326, 0.9362249970436096] |
| | | && V9 in (−Infinity, 1.25613135099411] && V3 in (−Infinity, 1.1987409591674805] |
| 4 | weight: 4.541494840006085 | rule: V9 in (−Infinity, 1.1219890713691711] && V5 in (−Infinity, |
| | | 0.9844518899917603] && V1 in (−0.4655628651380539, 1.0459327101707458] |
| 5 | weight: 324.4649166204716 | rule: V9 in (−0.49545857310295105, 0.9389763474464417] |
| | | && V5 in (−Infinity, 1.5171534419059753] && V1 in (−Infinity, 1.1954473853111267] |
| 6 | weight: 184.1669238869081 | rule: V1 in (−Infinity, 1.0673864483833313] && V7 in (−0.5264641642570496, |
| | | 0.8935272097587585] && V3 in (−Infinity, 1.4357870817184448] |
| 7 | weight: 440.9578270678034 | rule: V4 in (−Infinity, 1.4529091715812683] && V1 in (−0.468682125210762, |
| | | 1.0515859723091125] && V7 in (−Infinity, 1.4712920784950256] |
| 8 | weight: 425.9548714190155 | rule: V5 in (−0.5267625749111176, 0.9607195854187012] |
| | | && V2 in (−Infinity, 1.0498121976852417] && V7 in (−Infinity, 0.9225681722164154] |
| 9 | weight: 295.50390703871534 | rule: V4 in (−0.5633876621723175, 1.171735405921936] && |
| | | V6 in (−Infinity, 0.9280005097389221] && V3 in (−Infinity, 1.058317482471466] |
| 10 | weight: 417.5269730200762 | rule: V0 in (−Infinity, 1.4066649675369263] && V9 in (−0.5324947237968445, |
| | | 0.9375617206096649] && V5 in (−Infinity, 1.0262864828109741] |
| 11 | weight: 320.2736716721564 | rule: V4 in (−0.5705814063549042, 0.7919780910015106] |
| | | && V9 in (−Infinity, 1.2087704539299011] && V7 in (−Infinity, 1.2820829153060913] |
| 12 | weight: 441.71572187103 | rule: V9 in (−Infinity, 1.067348837852478] && V5 in (−0.4912244975566864, |
| | | 1.1779844760894775] && V2 in (−Infinity, 1.022316575050354] |
| 13 | weight: 285.08125659412843 | rule: V0 in (−Infinity, 1.5249618887901306] && V9 in (−0.5425787270069122, |
| | | 1.158622145652771] && V1 in (−Infinity, 1.0650025010108948] |
| 14 | weight: 437.6441885520025 | rule: V8 in (−0.524017870426178, 1.279581606388092] && |
| | | V5 in (−Infinity, 1.1000061631202698] && V7 in (−Infinity, 1.1830720901489258] |
| 15 | weight: 646.6495731237079 | rule: V4 in (−Infinity, 1.3259146809577942] && V7 in (−0.5135110020637512, |
| | | 0.8872847557067871] && V3 in (−Infinity, 1.4100686311721802] |
| 16 | weight: 836.8761727065086 | rule: V8 in (−Infinity, 1.2806495428085327] && V6 in (−0.5640947222709656, |
| | | 1.0739924311637878] && V2 in (−Infinity, 1.0594240427017212] |
| 17 | weight: 571.1073157929328 | rule: V1 in (−0.5213507413864136, 0.6552042365074158] |
| | | && V2 in (−Infinity, 1.421549141407013] && V3 in (−Infinity, 1.227742612361908] |

Model bias term(19)-3055.919022662963

FIG. 3 is a simplified block diagram of a computer system 300 according to an embodiment of the present invention. Computer system is an example of a computer system that can be used to implement the servers described above in connection to system 100, or the computer systems described above in connection with FIG. 2. In the present embodiment, computer system 300 typically includes a monitor 310, computer 320, a keyboard 330, a user input device 340, computer interfaces 350, and the like.

In the present embodiment, user input device 340 is typically embodied as a computer mouse, a trackball, a track pad, a joystick, wireless remote, drawing tablet, voice command system, eye tracking system, and the like. User input device 340 typically allows a user to select objects, icons, text and the like that appear on the monitor 310 via a command such as a click of a button or the like.

Embodiments of computer interfaces 350 typically include an Ethernet card, a modem (telephone, satellite, cable, ISDN), (asynchronous) digital subscriber line (DSL) unit, FireWire interface, USB interface, and the like. For example, computer interfaces 350 may be coupled to a computer network bus 355, to a FireWire bus, or the like. In other embodiments, computer interfaces 350 may be physically integrated on the motherboard of computer 320, may be a software program, such as soft DSL, or the like.

In various embodiments, computer 320 typically includes familiar computer components such as a processor 360, and memory storage devices, such as a random access memory (RAM) 370, disk drives 380, and system bus 390 interconnecting the above components.

In one embodiment, computer 320 includes one or more microprocessors from Intel. Further, in the present embodiment, computer 320 may include a Windows-based operating system from Microsoft Corporation.

RAM 370 and disk drive 380 are examples of tangible media configured to store data such as data sources, embodiments of thematic extraction engines, thematic indices, application programs, and the like. The data stored may be in the form of computer-readable code, human-readable code, or the like. Other types of tangible media include internal storage or distribution media, such as floppy disks, removable hard disks, optical storage media such as CD-ROMS, DVDs, holographic memory, and bar codes, semiconductor memories such as flash memories, read-only-memories (ROMS), battery-backed volatile memories, networked storage devices, and the like.

In the present embodiment, computer system 300 may also include software that enables communications over a network such as the HTTP, TCP/IP, RTP/RTSP protocols, and the like. In alternative embodiments of the present invention, other communications software and transfer protocols may also be used, for example IPX, UDP or the like.

FIG. 3 is representative of a computer system capable of embodying the present invention. It will be readily apparent to one of ordinary skill in the art that many other hardware and software configurations are suitable for use with the present invention. For example, the computer may be an end-user desktop or portable; a network storage server configured in a rack-mounted or stand-alone configuration; a centralized server; or the like. Additionally, the computer may be a series of networked computers. Further, the use of microprocessors such as the Pentium™ or Itanium™ microprocessors; Opteron™ or AthlonXP™ microprocessors from Advanced Micro Devices, Inc; G4 or G5 microprocessors from IBM; and the like are contemplated. Further, other types of operating systems are contemplated, such as Windows®, WindowsXP®, WindowsNT®, or the like from Microsoft Corporation, Solaris from Sun Microsystems, LINUX, UNIX, and the like. In still other embodiments, the techniques described above may be implemented upon a chip or an auxiliary processing board (e.g. graphics processor unit).

It is also understood that the examples and embodiments described herein are for illustrative purposes only and that various modifications or changes in light thereof will be suggested to persons skilled in the art and are to be included within the spirit and purview of this application and scope of the appended claims.

What is claimed is:

1. In a network monitoring tool implemented in a computer system having one or more computer processors and a computer-readable storage medium, a method for evaluating transactions in a network, the method comprising:
retrieving from the computer-readable storage medium information about network transactions;
generating, with one or more of the computer processors, a machine learning model for evaluating the network transactions;
generating, with one or more of the computer processors, a plurality of rule candidates from the machine learning model;
reducing with one or more of the computer processors, the number of rules in the plurality of rule candidates;
forming an optimized set of rules for evaluating the network transactions; and
outputting the optimized set of rules in a human readable form.

2. The method of claim 1, wherein retrieving information about network transactions comprising receiving historical information about network transaction.

3. The method of claim 1, wherein retrieving information about network transactions comprising receiving real-time on-line information about network transaction.

4. The method of claim 1, wherein forming an optimized set of rules comprises:
selecting variables; and
selecting partitions of values of the variables.

5. The method of claim 4, further comprising:
selecting the top performing rules; and
determining the optimal weight combination for the rules.

6. The method claim 5, further comprising:
receiving, from a user, a number of rules and a number of variables for each rules.

7. The method of claim 1, wherein generating the machine learning model comprises using one or more of neural networks methods, SVM methods, or ensemble methods.

8. The method of claim 1, wherein generating the plurality of rule candidates from the machine learning model comprises using one or more of a DIMLP method or a C4.5rules method.

9. The method of claim 1, wherein reducing the number of rules in the plurality of rule candidates comprises using one or more of methods based on business needs or heuristic methods.

10. The method of claim 1, wherein forming an optimized set of rules comprises using one or more of filter methods or embedded methods.

11. In a computer system, a method for evaluating transactions in a network, the method comprising:
receiving a plurality of transactions over the network;
automatically generating rules for evaluating the transactions, using the computer system, each of the rules includes variables and partition of values of the variables, each partition having an assigned score; and
using the computer system, automatically combining the rule scores to form a final score.

12. A computer system for evaluating transactions in a network, the system comprising:
a storage medium;
one or more processors coupled to said storage medium; and
computer code stored in said storage medium wherein said computer code, when retrieved from said storage medium and executed by said one or more processor, results in:
retrieving from the computer-readable storage medium information about network transactions;
generating, with one or more of the computer processors, a machine learning model for evaluating the network transactions;
generating, with one or more of the computer processors, a plurality of rule candidates from the machine learning model;
reducing with one or more of the computer processors, the number of rules in the plurality of rule candidates;
forming an optimized set of rules for evaluating the network transactions; and
outputting the optimized set of rules in a human readable form.

13. The system of claim 12, wherein retrieving information about network transactions comprising receiving historical information about network transaction.

14. The system of claim 12, wherein retrieving information about network transactions comprising receiving real-time on-line information about network transaction.

15. The system of claim 12, wherein forming an optimized set of rules comprises:
selecting variables; and
selecting partitions of values of the variables.

16. The system of claim 15, further comprising:
selecting the top performing rules; and
determining the optimal weight combination for the rules.

17. The system of claim 16, further comprising:
receiving, from a user, a number of rules and a number of variables for each rules.

18. The system of claim 12, wherein generating the machine learning model comprises using one or more of neural networks methods, SVM methods, or ensemble methods.

19. The system of claim 12, wherein generating the plurality of rule candidates from the machine learning model comprises using one or more of a DIMLP method or a C4.5rules method.

20. The system of claim 12, wherein reducing the number of rules in the plurality of rule candidates comprises using one or more of methods based on business needs or heuristic methods.

21. The system of claim 12, wherein forming an optimized set of rules comprises using one or more of filter methods or embedded methods.
